(19) United States
(12) Patent Application Publication
(10) Pub. No.: US 2026/0216687 A1
(43) Pub. Date: Jul. 30, 2026

(54) Modular Annular Dosing and Mixing Reactor System

(71) Applicant: Adalberto Mercado Alvarado, Bayamon, PR (US)

(72) Inventor: Adalberto Mercado Alvarado, Bayamon, PR (US)

(21) Appl. No.: 19/572,548

(22) Filed: Mar. 19, 2026

Related U.S. Application Data
(63) Continuation-in-part of application No. 19/041,033, filed on Jan. 30, 2025.

(51) Int. Cl. B01J 19/26; B01J 19/18

(52) U.S. Cl. CPC B01J 19/26; B01J 19/18; B01J 2219/00162

(57) ABSTRACT

A modular annular dosing and mixing reactor system is provided, that includes a ring-shaped reactor body that defines a continuous circumferential internal channel surrounding a central reactor chamber. Dilution water enters through an inlet port and is distributed into the chamber by circumferential spray nozzles. A progressive cavity dosing interface delivers neat polymer directly into the annular flow path for controlled mixing and activation. The reactor incorporates replaceable wear-interface components and sealing elements that isolate threaded loads and protect transparent or chemically sensitive materials. A sealed drive penetration with a mechanical seal and submersible joint enables operation of internal flow-conditioning or mixing elements within the chamber. The architecture supports multiple mounting orientations, including drum, tote, and inline configurations, and may be formed from transparent materials to permit real-time visual inspection. The system provides uniform residence time, controlled shear, and efficient chemical activation in a compact, field-serviceable design.

### CROSS-REFERENCE TO RELATED APPLICATIONS

This application is a continuation-in-part of, and claims the benefit of priority to, U.S. application Ser. No.19/041,033 titled “Liquid Polymer Dosing and Mixing Chamber with an External Actuator,” and filed on Jan. 30, 2025, and the contents of which, are hereby incorporated by reference.

### FIELD OF THE INVENTION

The subject disclosure relates to systems and apparatuses for liquid-phase dosing, mixing, and chemical conditioning, and more particularly to annular reactors configured for controlled circumferential flow and optimized polymer or chemical activation.

### BACKGROUND

Polymer activation systems, annular reactors, and liquid-phase chemical mixers are widely used in water and wastewater treatment, industrial processing, and chemical-preparation applications. These systems must reliably combine a neat polymer, chemical, or additive with dilution water under controlled shear and residence-time conditions to produce a uniformly activated or blended solution suitable for downstream use. Conventional polymer-activation equipment typically relies on multi-chamber tanks, static mixers, or open-channel designs in which polymer and dilution water are combined through a sequence of baffles or mechanical agitation stages. While these systems can achieve partial activation, they frequently generate non-uniform mixing zones, unpredictable residence times, inconsistent shear exposure, and localized high-energy regions. These process limitations can lead to excessive polymer consumption, degradation of shear-sensitive materials, or incomplete activation of the resulting polymer solution.

Positive-displacement pumps, especially progressive cavity pumps, are commonly used to meter viscous polymer concentrates into chemical-conditioning systems. However, known configurations often deliver the polymer into simple piping tees, static mixer housings, or open tanks without establishing controlled annular flow or uniform circumferential exposure to dilution water. These uncontrolled mixing geometries often result in slugging, agglomeration, poor wetting, and non-homogeneous activation—issues that become more pronounced in compact skid systems or portable drum-mounted and tote-mounted units where available mixing length is limited. Another longstanding challenge in the field is the structural vulnerability of transparent or translucent reactor components. Materials such as acrylic or cast polymer allow valuable visual observation of internal mixing behavior but are prone to cracking, crazing, and long-term deterioration when exposed to direct thread loads, overtightened fittings, vibration, or chemical attack. Conventional designs that rely on threaded ports cut directly into such materials often experience premature failure, leakage, or loss of pressure integrity during service.

Existing systems also often lack modular, field-replaceable sacrificial interface components—such as threaded inserts, bushings, unions, and wear sleeves—that can isolate mechanical loads and wear from the primary reactor structure. As a result, when ports become damaged or chemically degraded, many polymer-conditioning devices require full disassembly or replacement of large structural sections, leading to significant downtime and maintenance cost. This lack of replaceability also discourages the use of transparent materials in high-pressure or industrial environments.

Sealed internal-drive systems or submersible actuators are sometimes used to impart internal mixing energy within enclosed reactors. However, existing designs tend to require complex penetrations, oversized housings, or shaft-seal arrangements that are difficult to integrate into compact annular geometries. These designs may introduce additional leak paths, require specialized maintenance procedures, or reduce the practicality of using such systems in portable, small-footprint, or modular installations.

Accordingly, there remains a need for a compact, modular annular chemical-conditioning reactor that addresses the limitations of conventional systems. Such a reactor should provide controlled circumferential flow, uniform and predictable residence time, and efficient dilution-and-activation mixing of polymer and other chemicals. It should further integrate precise positive-displacement dosing, robust sealed internal-drive capabilities, and replaceable sacrificial interface components that protect environmentally sensitive or transparent reactor materials. A system capable of installation on drums, totes, or inline piping, while also supporting visual inspection of internal flow conditions, would resolve multiple deficiencies that persist in current polymer-activation and chemical-conditioning technologies.

### SUMMARY

The subject disclosure relates to a modular annular dosing and mixing reactor system comprising an annular reactor that includes a reactor body having an external wall and an internal wall that together define a continuous circumferential internal channel surrounding a reactor chamber, the annular reactor further including an inlet channel and an outlet channel, and one or more spray nozzles mounted on or through the internal wall and oriented to discharge fluid from the internal channel into the reactor chamber; a first cover plate secured to a first end of the reactor body and a second cover plate secured to a second end of the reactor body, each of the first cover plate and the second cover plate having a central opening, the central openings being coaxially aligned; a first process port having a port body with an inlet and an internal port channel in fluid communication with the inlet channel so that fluid admitted at the inlet is conveyed to the internal channel for discharge via the spray nozzles into the reactor chamber; a second process port having a port body with an outlet and an internal port channel in fluid communication with the outlet channel to withdraw mixed contents from the reactor chamber; and a polymer dosing interface comprising a stator assembly including an exterior stator coupling defining a polymer-inlet opening, an interior stator coupling, and a stator captured between the exterior and interior stator couplings, and further comprising a longitudinal shaft extending through the central opening of the first cover plate and through the central opening of the second cover plate, the longitudinal shaft being coupled at a first end to the stator assembly and at a second end to a shaft-coupling structure mounted to the second cover plate and for connection to a motor drive, and further comprising a mechanical seal arranged at a drive penetration of the second cover plate and surrounding the longitudinal shaft to maintain pressure integrity; wherein the polymer-inlet opening communicates through the stator assembly into the internal channel of the reactor body.

The system is designed to deliver uniform residence time, controlled shear, and efficient chemical activation within a compact and maintainable assembly. During operation, dilution water entering through the first process port is sprayed into the reactor chamber to mix with neat polymer introduced through the polymer-inlet housing of the stator assembly. The annular geometry imposes a controlled circumferential flow path that promotes uniform exposure time and avoids excessive shear, enhancing polymer activation efficiency while limiting degradation. The resulting polymer solution is guided to the second process port for discharge. The reactor may be mounted in horizontal or vertical orientations and includes attachment features for drum-, tote-, or inline-installation frames. Replaceable wear components, accessible fasteners, and modular couplings throughout the system enable rapid servicing while protecting transparent or chemically sensitive materials and preserving long-term pressure integrity.

### BRIEF DESCRIPTION OF THE DRAWINGS

FIG. 1 shows an annular dosing and mixing reactor system, in accordance with the principles of the present invention.

FIG. 2 shows a perspective view of the annular dosing and mixing reactor system.

FIG. 3 shows a right-side view of the annular dosing and mixing reactor system.

FIG. 4 shows a left-side view of the annular dosing and mixing reactor system.

FIG. 5 shows a bottom view of the annular dosing and mixing reactor system.

FIG. 6 shows a top view of the annular dosing and mixing reactor system.

FIG. 7 shows a front view of the annular dosing and mixing reactor system.

FIG. 8 shows a rear view of the annular dosing and mixing reactor system.

FIG. 9 highlights the inlet and outlet components of the annular dosing and mixing reactor system.

FIG. 10 shows an exploded view of the components of the annular dosing and mixing reactor system.

FIG. 11 illustrates the flow path of the substances as they enter the annular reactor, traverse the internal channel, and are discharged into the reactor chamber for mixing within the annular dosing and mixing reactor system.

FIGS. 12-15 show a second embodiment of the annular dosing and mixing reactor system.

FIGS. 16-19 show a third embodiment of the annular dosing and mixing reactor system.

FIGS. 20-21 show a fourth embodiment of the annular dosing and mixing reactor system

### DETAILED DESCRIPTION

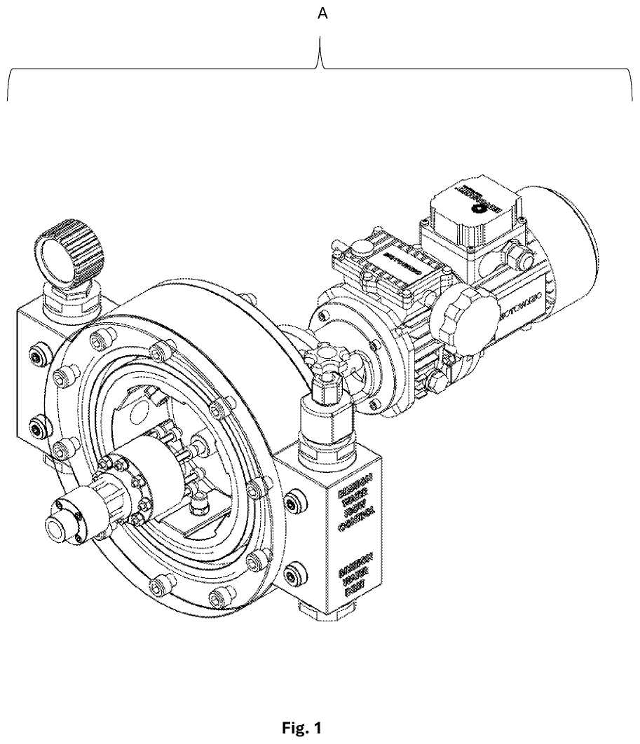

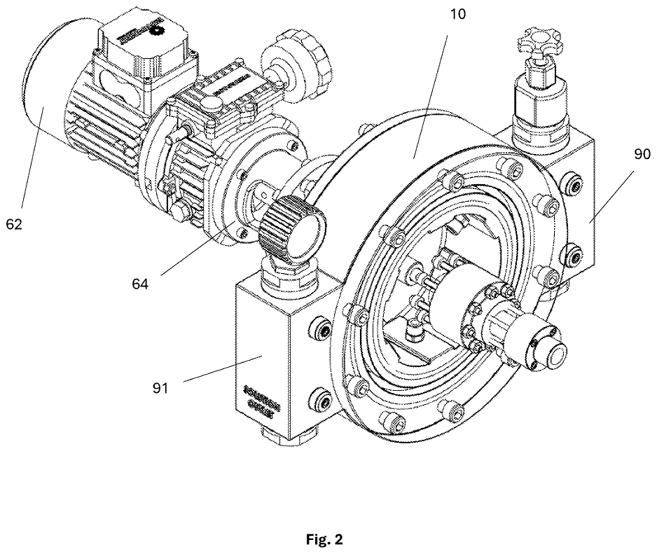

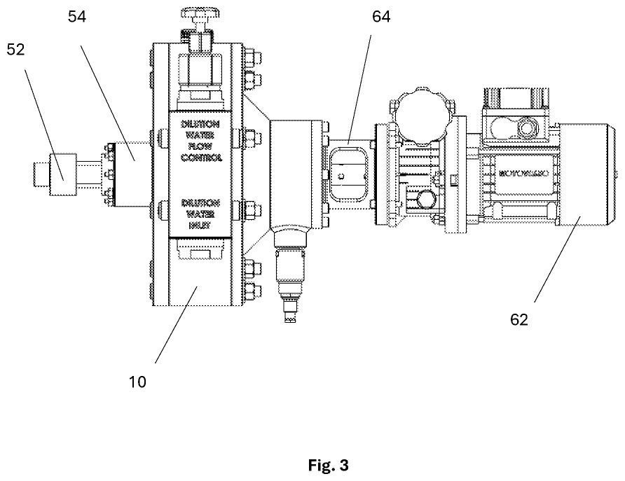

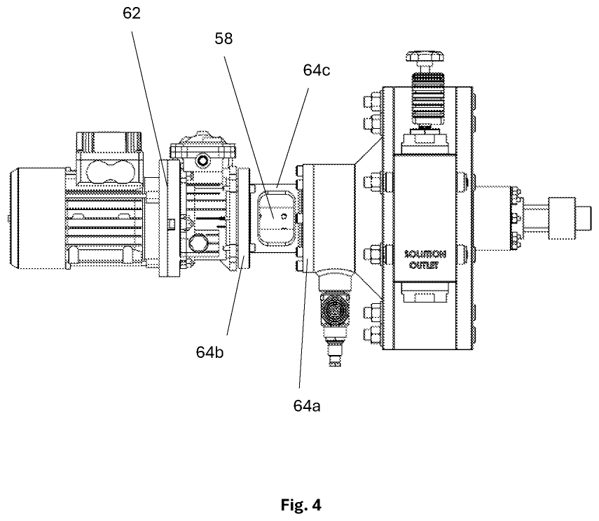

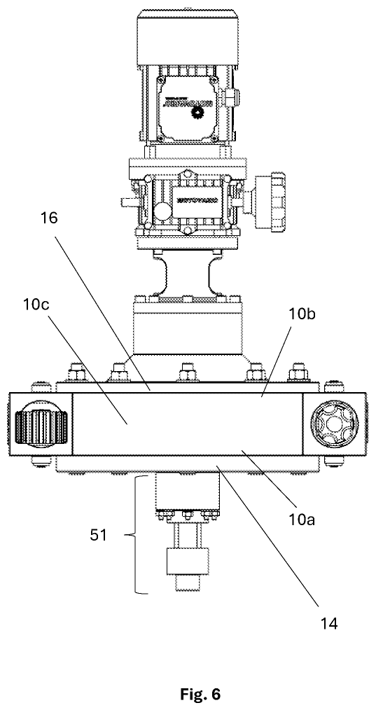

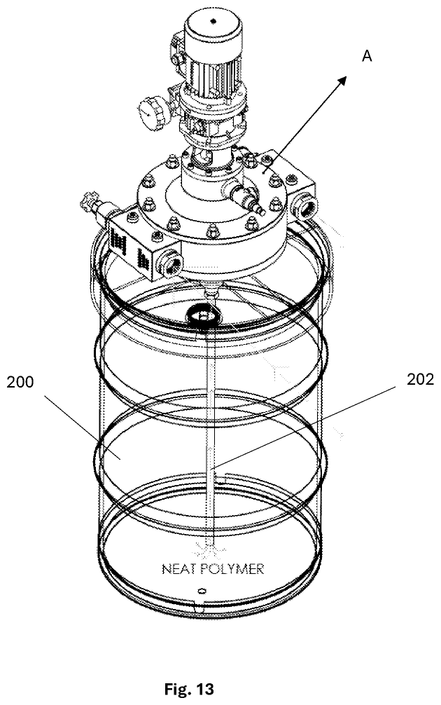

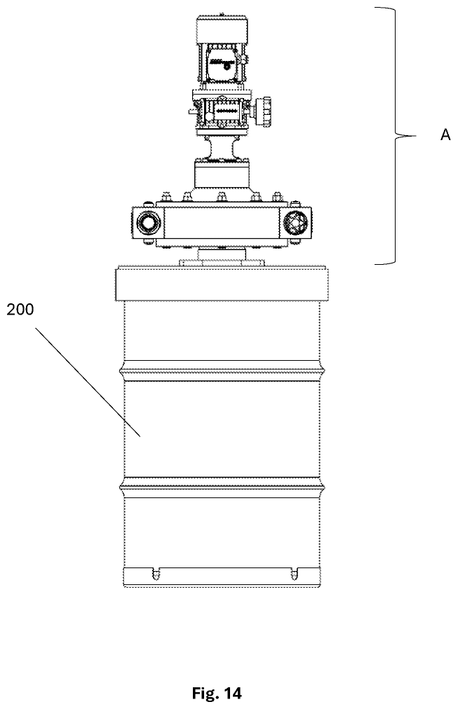

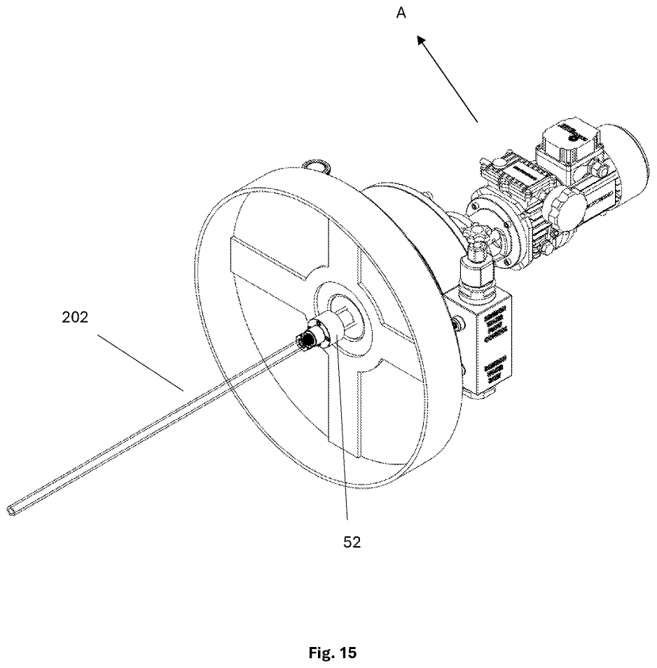

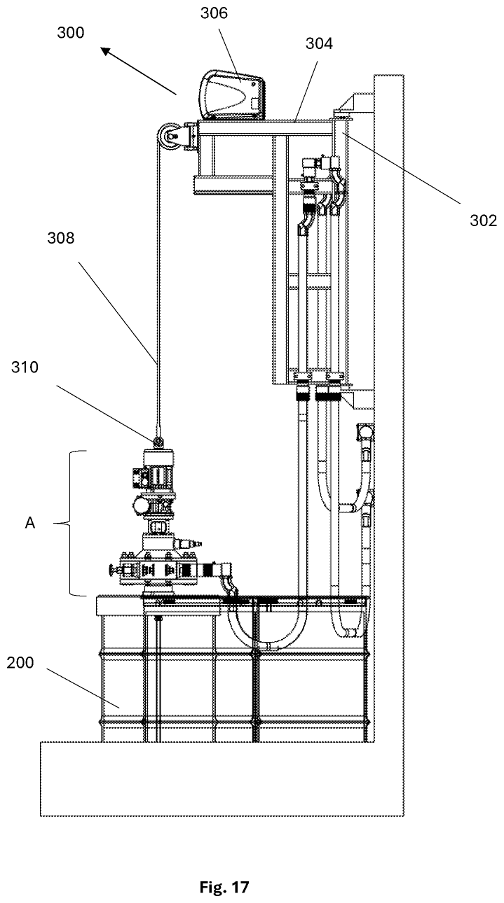

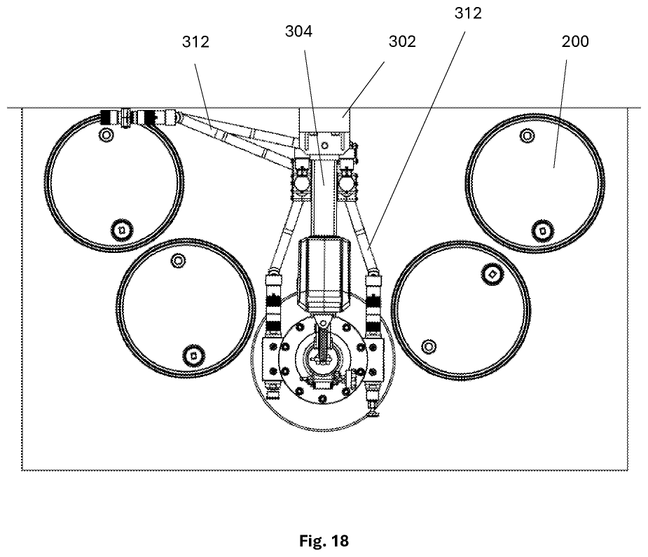

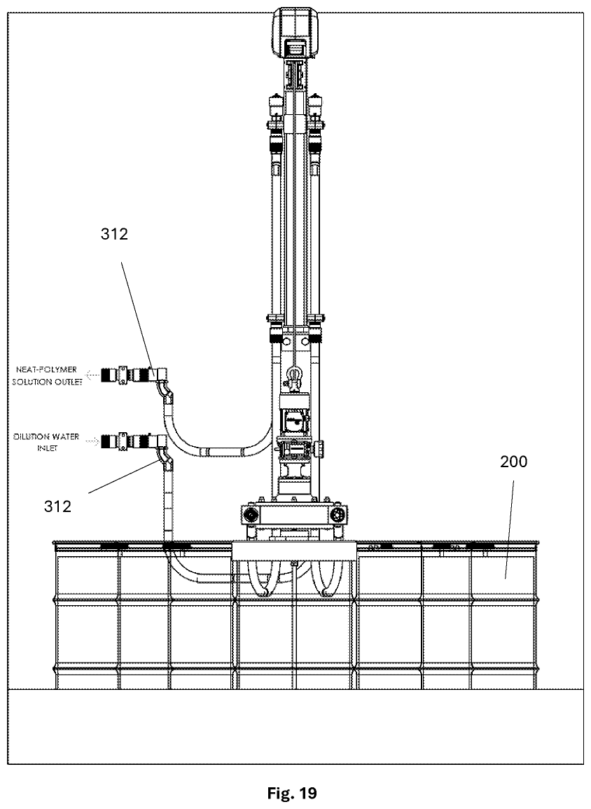

As shown in FIGS. 1-21, the subject disclosure relates to a modular annular dosing and mixing reactor system (A) that includes an annular chemical-conditioning reactor (10) having a ring-shaped reactor body defining a continuous circumferential internal channel that extends around a central axis. Within this geometry, dilution water and a neat polymer or other chemical are introduced into the annulus, where they combine and undergo mixing and conditioning before exiting the system. The ring-shaped internal channel provides a controlled circumferential residence path that maintains uniform exposure time and consistent shear conditions as the mixture travels around the annulus, thereby enhancing activation efficiency while reducing polymer degradation. The annular reactor (10) may be oriented horizontally or vertically and may be mounted on drum or tote fixtures or installed inline within a piping system, with the modular architecture allowing mounting hardware to be exchanged without altering the internal annular flow path.

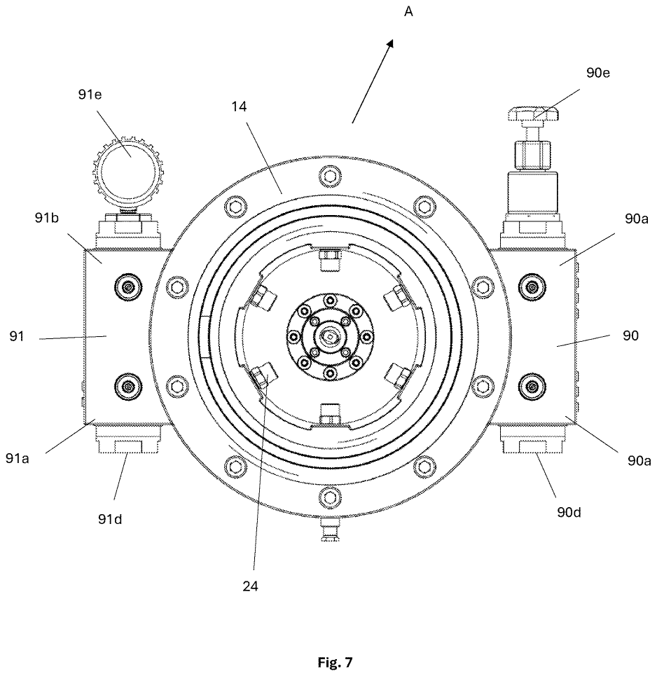

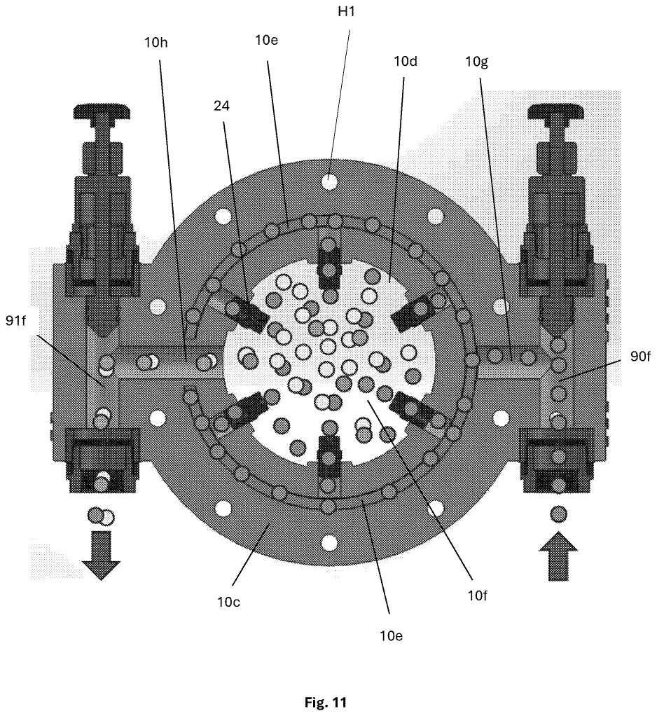

As shown in FIGS. 1-6, the annular reactor (10) is a ring-shaped structure comprising a first end (10a), a second end (10b), and a reactor body (10c) extending between the first end (10a) and the second end (10b). The reactor body (10c) includes an external wall positioned to face the surrounding environment, an internal wall positioned radially inward of the external wall, and an internal channel (10e) that is defined circumferentially between the external wall and the internal wall and extends continuously around the annular reactor body (10c). A central annular space (10d) is bounded at least in part by the internal wall of the reactor body (10c), and this central annular space (10d) defines a reactor chamber (10f) located radially inward of the internal channel (10e). The annular reactor (10) further comprises one or more spray nozzles (24) positioned on or through the internal wall of the reactor body (10c), each spray nozzle being oriented to discharge a fluid from the internal channel (10e) into the reactor chamber (10f), as shown in FIGS. 7 and 11. The annular reactor (10) also includes an inlet channel (10g) that is adapted to guide a first substance into the reactor chamber (10f) from the first process port (90); and an outlet channel (10h) adapted to guide mixed substances from the reactor chamber (10f) into the second process port (91), as further discussed below. It should be noted that both the first end (10a) and the second end (10b) of the annular reactor (10) include one or more holes or openings (H1) along their respective circumferences, each hole being sized and positioned to receive one or more

### Interconnecting Bolts (18).

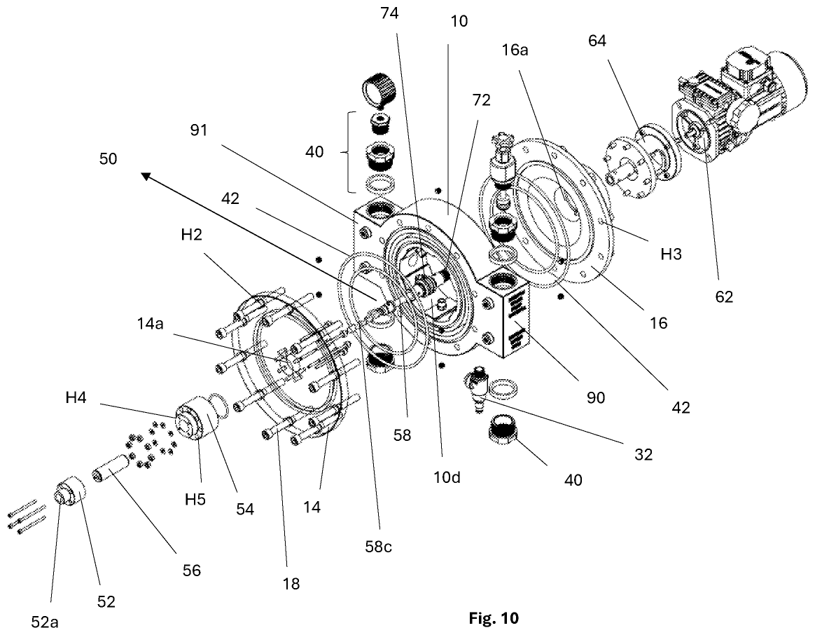

As shown in FIG. 10, the annular reactor (10) further comprises a first cover plate (14) coupled to the first end (10a) of the annular reactor (10) and a second cover plate (16) coupled to the second end (10b) of the annular reactor (10). The first cover plate (14) includes a plurality of holes or openings (H2) that correspond to and align with the plurality of holes or openings (H1) located on the first end (10a) of the annular reactor (10), wherein said holes or openings (H2) on the first cover plate (14) are adapted to receive the one or more interconnecting bolts (18), thereby securely fastening the first cover (14) to the first end (10a) of the annular reactor (10). Likewise, the second cover plate (16) comprises a plurality of holes or openings (H3) that correspond to and align with the plurality of holes or openings (H1) on the second end (10b) of the annular reactor (10), wherein said holes or openings (H3) are adapted to receive the one or more interconnecting bolts (18), thereby securely fastening the second cover (16) to the second end (10b) of the annular reactor (10). The second cover plate (16) further includes a central opening (16a) adapted to provide access to the longitudinal shaft (58) component of the polymer dosing interface (50) into the reactor chamber (10f); and also allows the second end of the longitudinal shaft (58) to couple to motor assembly. The interconnection bolts (18) include corresponding nuts and washers arranged to clamp the cover plates to the reactor body (10c). Each cover plate-to-annular reactor interface incorporates an annular elastomeric seal (42), such as an O-ring or a flat face gasket seated in a circumferential groove formed in at least one of the mating surfaces, the annular elastomeric seal (42) being axially compressed by the interconnection bolts (18) to produce a fluid-tight joint. In certain embodiments, the first cover plate (14) is formed from a transparent or translucent polymeric material, such as acrylic or SLA-printed resin, permitting direct visual observation of internal flow behavior, spray-jet interaction, and mixing uniformity during operation.

As shown in FIG. 10, the first cover plate (14) further includes a central opening (14a) sized and positioned to receive the longitudinal shaft (58) of the polymer dosing interface (50) so that the first end of the longitudinal shaft (58) extends through the first cover plate (14) and couples to the stator (56) of the progressive-cavity pump assembly. Likewise, the second cover plate (16) includes a central opening (16a) sized and positioned to receive the longitudinal shaft (58) at its opposite end, allowing the second end of the longitudinal shaft (58) to extend through the second cover plate (16) and couple to the motor-side shaft-coupling structure (64) and the motor drive (62). Each central opening (14a, 16a) is arranged coaxially with the longitudinal shaft (58) to maintain alignment between the stator-side connection and the motor-side coupling across the annular reactor (10) and through the reactor chamber (10f).

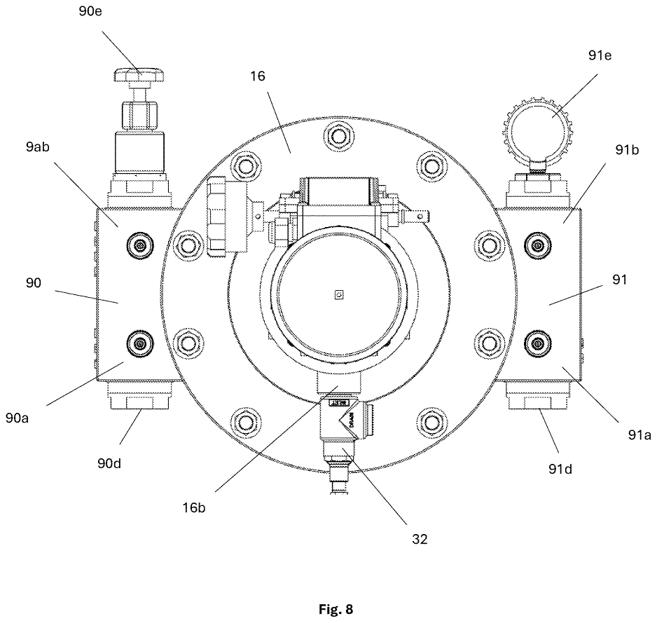

As shown in FIGS. 7 and 8, the annular reactor (10) includes a first process port (90) and a second process port (91) attached to the reactor body (10c). The first process port (90) comprises a longitudinal body having a first end (90a) and a second end (90b) opposite each other, and one or more sidewalls (90c) extending between the first end (90a) and the second end (90b). The first end (90a) of the first process port (90) includes at least one inlet (90d) configured to receive a first substance, such as dilution water or another fluid; whereas the second end (90b) of the first process port (90) may optionally support a flow control valve (90e) for regulating the pressure or flow rate of the incoming substance. The first process port (90) further comprises an internal channel (90f) configured to guide the first substance from the inlet (90d) into the internal channel (10e) of the annular reactor (10), via the inlet channel (10g), and from which the substance is directed into the reactor chamber (10f) through the one or more spray nozzles (24) to mix with polymer introduced through the polymer inlet (52a). As such, the inlet channel (10g) fluidly connects the internal channel (90f) of the first process port (90) to the internal channel (10e) of the annular reactor (10). Lastly, at least one of the sidewalls (90c) of the first process port (90) is attached to the reactor body (10c) to provide fluid communication between the internal channel (90f) and the internal channel (10e) of the annular reactor (10).

Likewise, as shown in FIGS. 7 and 8, the second process port (91) comprises a longitudinal body having a first end (91a) and a second end (91b) opposite each other, and one or more sidewalls (91c) extending between the first end (91a) and the second end (91b), as shown in FIGS. 7 and 8. The first end (91a) of the second process port (91) includes an outlet (91d) adapted to release the polymer solution mixed within the reactor chamber (10f); whereas the second end (91b) of the second process port (91) may optionally support a pressure gauge (91e). The second process port (91) further comprises an internal channel (91f) configured to guide the mixed substances within the reactor chamber (10f) into the outlet (91d) via the outlet channel (10h). As such, the outlet channel (10h) fluidly connects the internal channel (91f) of the second process port (91) to the reactor chamber (10f) of the annular reactor (10). Lastly, at least one of the sidewalls (91c) of the second process port (91) is attached to the reactor body (10c).

The first end of each process port (90, 91) may comprise a replaceable wear-interface component (40), the replaceable wear-interface component (40) being selected from a threaded insert, a reducer, a union, a bushing, or a wear sleeve. Each replaceable wear-interface component (40) presents a metal or reinforced polymer thread for connection to external piping, and each is sealed to the adjacent plate or body surface by a dedicated seal (42) arranged as an O-ring or face gasket.

The annular reactor (10) may also comprise a pressure relief valve (32) mounted to the second cover plate (16) at a relief-valve port (16b) that opens to the reactor chamber (10f) or to the internal channel (10e) as arranged. The relief-valve port (16b) includes a through-bore sized to receive a replaceable wear-interface component (40) presenting a threaded or flanged connection for the pressure relief valve (32). A sealing element (42) is positioned between the replaceable wear-interface component (40) and the second cover plate (16) to maintain a fluid-tight interface under operating pressure. The pressure relief valve (32) comprises a valve body coupled to the replaceable wear-interface component (40), an internal spring-and-seat assembly calibrated to open at a predetermined set pressure, and a discharge outlet connected to a relief conduit directed to a safe location or return manifold. In some implementations, the valve body includes a test port and a manual reset or lift mechanism accessible from outside the second cover plate (16) to verify valve function. The mounting orientation of the pressure relief valve (32) on the second cover plate (16) is selected to maintain vertical or near-vertical alignment of the internal spring-and-seat assembly and to provide unobstructed routing of the relief conduit. The use of the replaceable wear-interface component (40) at the relief-valve port (16b) isolates mechanical loads and service wear from the second cover plate (16) and permits field replacement of the pressure relief valve (32) without disassembling the annular reactor (10).

Each spray nozzle (24) is received within a nozzle bore formed through the internal wall of the reactor body (10c). A nozzle-to-wall seal (42) is positioned between the exterior surface of the spray nozzle (24), and the surrounding wall of the nozzle bore to maintain a fluid-tight interface. The seal (42) prevents leakage of dilution water around the nozzle body and ensures that the water entering the nozzle is discharged solely through the nozzle orifice into the reactor chamber (10f), thereby preserving controlled spray distribution and pressure integrity.

As shown in FIG. 10, the annular reactor (10) includes a polymer dosing interface (50) that comprises a stator assembly (51) and a longitudinal shaft (58) arranged to provide a sealed mechanical and fluid pathway between a progressive-cavity pump assembly and the reactor chamber (10f). The polymer dosing interface (50) further includes a motor-side shaft-coupling structure (64) connected to a motor drive (62) and a mechanical seal (72) that surrounds the longitudinal shaft (58) at the drive penetration of the second cover plate (16) to maintain pressure integrity. It should be noted that the first cover plate (14) includes a central opening (14a) sized and positioned to receive the longitudinal shaft (58) at the stator side, and the second cover plate (16) includes a central opening (16a) arranged coaxially with the opening (14a) so that the longitudinal shaft (58) passes between the cover plates in maintained alignment across the reactor chamber (10f).

The longitudinal shaft (58) comprises a first end (58a) and a second end (58b) disposed opposite each other. The first end (58a) couples through the central opening (14a) of the first cover plate (14) to the rotor (58c), thereby locking the rotor (58c) and the longitudinal shaft (58) together as a torque-transmitting assembly. The second end (58b) couples to the shaft-coupling structure (64) mounted at the second cover plate (16) for connection to the motor drive (62). In operation, rotational power flows from the motor drive (62) through the shaft-coupling structure (64) and the longitudinal shaft (58) to the rotor (58c), which rotates within the stator (56) to create progressive displacement that meters polymer through the rotor- stator cavity and into the reactor chamber (10f). The mechanical seal (72) is arranged at the drive penetration of the second cover plate (16) and surrounds the longitudinal shaft (58) to maintain pressure integrity during rotation.

The stator assembly (51), in turn, comprises an exterior stator coupling unit (52), an interior stator coupling unit (54), a stator (56), and a rotor (58c) positioned within the stator (56) and arranged coaxially with the longitudinal shaft (58) and the central opening (14a) of the first cover plate (14). The stator (56) is captured and supported between the exterior stator coupling unit (52) and the interior stator coupling unit (54), with one or more seals (42) positioned at the interfaces to maintain pressure integrity. The stator (56) comprises a tubular body presenting an internal double-helix pumping cavity sized to receive the rotor (58c), the tubular body having a pair of axial end faces configured to register against corresponding seats of the exterior stator coupling unit (52) and the interior stator coupling unit (54). In one implementation, the stator (56) includes an elastomeric sleeve bonded or interference-fitted within a rigid outer shell to maintain dimensional stability under pressure and temperature, the outer shell being non-rotatable relative to the coupling units (52, 54). he stator's internal profile defines alternating seal lines and cavities that cooperate with the single-helix rotor (58c) to form discrete, progressing chambers during rotation. Anti-rotation features—such as flats, keys, pins, or splines—may be provided at one or both axial ends of the stator (56) to prevent torsional movement relative to the coupling units (52, 54), and optional end rings or compression seats may be employed to set axial preload and to protect the elastomeric sleeve at the interfaces. The stator (56) thus provides a stationary, pressure-retaining liner that, together with the rotor (58c), defines the sealed pumping cavity through which polymer advances toward the reactor chamber (10f).

The exterior stator coupling unit (52) is a longitudinal housing having a first end and a second end opposite each other. The first end of the exterior stator coupling unit (52) includes a polymer-inlet opening (52a) configured to receive neat polymer from an external feed line. The second end of the exterior stator coupling unit (52) is adapted to receive and axially register a first end region of the stator (56), and to seat a seal (42) against the first cover plate (14) to provide a fluid-tight interface. The exterior stator coupling unit (52) defines an internal passage that directs polymer from the polymer-inlet opening (52a) toward the stator (56) and the rotor (58c) received therein. Polymer admitted at the polymer-inlet opening (52a) is directed into a rotor-stator pumping cavity, where rotation of the rotor (58c) within the stator (56) meters polymer along a common axis toward the reactor chamber (10f) of the annular reactor (10).

The interior stator coupling unit (54) is a longitudinal housing having a first end and a second end opposite each other. The first end of the interior stator coupling unit (54) is positioned inward of the first cover plate (14) and is adapted to receive and axially register an opposite end region of the stator (56) so that the stator (56) is captured between the exterior stator coupling unit (52) and the interior stator coupling unit (54). The second end of the interior stator coupling unit (54) is coupled to the first cover plate (14) and is aligned with the central opening (14a) to provide access for the longitudinal shaft (58) to couple with the rotor (58c). The interior stator coupling unit (54) defines a through-passage coaxial with the longitudinal shaft (58) to maintain alignment of the rotor (58c) and stator (56) and seats one or more seals (42) at its interface to the first cover plate (14).

The rotor (58c) comprises a first end and a second end opposite each other. The rotor (58c) is positioned within the stator (56) such that the rotor's second end includes a coupling unit configured to couple with and mechanically attach to the first end of the longitudinal shaft (58), thereby locking the rotor (58c) and the longitudinal shaft (58) together as a torque-transmitting assembly. In this arrangement, rotational power delivered to the longitudinal shaft (58) causes the rotor (58c) to rotate within the stator (56), metering polymer received through the polymer-inlet opening (52a) and directing it into the reactor chamber (10f) for mixing with dilution water discharged from the internal channel (10e) via the spray nozzles (24).

It should be noted that in one embodiment the exterior stator coupling unit (52) and the interior stator coupling unit (54) are attached to each other by one or more bolts. Specifically, the interior stator coupling unit (54) includes a first set of openings (H4) that align and correspond with one or more openings in the exterior stator coupling unit (52); and that are adapted to receive the one or more bolts to secure the two units to each other. The interior stator coupling unit (54) further includes a second set of openings (H5) that align and correspond with one or more openings in the first cover plate (14) and that are adapted to receive one or more bolts to secure the interior stator coupling unit (54) to the first cover plate (14).

The stator (56) is seated between the exterior stator coupling unit (52) and the interior stator coupling unit (54) so that polymer entering through the polymer inlet (52a) of the exterior stator coupling (52) is directed into a pumping cavity defined between the rotor (58c) and the stator (56) and advanced along the axis of the longitudinal shaft (58) into the internal channel (10e) of the reactor body (10c). The rotor (58c) presents a shaft-engagement interface and is coupled to the first end (58a) of the longitudinal shaft (58) through the central opening (14a) so that rotation of the longitudinal shaft (58) drives rotation of the rotor (58c) within the stator (56).

The central openings (14a, 16a) in the first cover plate (14) and the second cover plate (16) are arranged coaxially with the longitudinal shaft (58) to maintain alignment between the stator-side connection at the first cover plate (14) and the motor-side connection at the second cover plate (16). In assembly, the first end of the shaft (58) extends through the opening (14a) to engage the rotor (58c) positioned within the stator (56) of the stator assembly (51), and the second end extends through the opening (16a) to engage the motor-side coupling.

The second end of the longitudinal shaft (58) passes through the central opening (16a) of the second cover plate (16) and into a shaft-coupling structure (64) mounted to the outer face of the second cover plate (16). A mechanical seal is arranged at the drive-penetration region of the second cover plate (16) around the shaft (58) to maintain pressure integrity during rotation. A submersible joint assembly (74) may be positioned at the interior side of the drive penetration and coupled to the longitudinal shaft (58) so as to transmit torque to an internal mixing or flow-conditioning element located within the reactor chamber (10f). As such, the submersible joint assembly (74) is located on the inside of the chamber (10f), immediately adjacent to or directly inward of the mechanical seal and the cover plate (16).

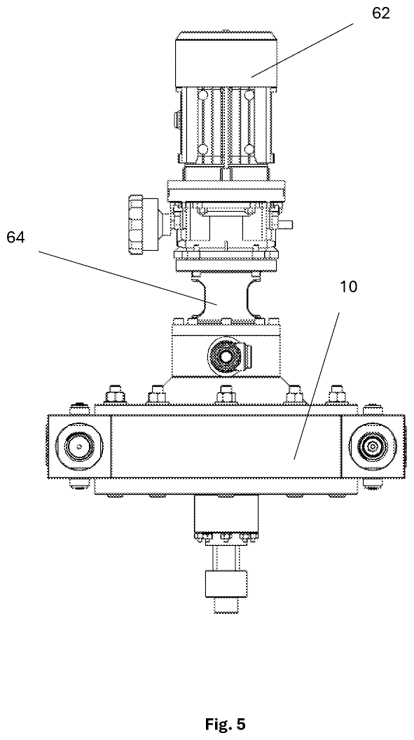

As shown in FIG. 5, the shaft-coupling structure (64) comprises a longitudinal housing having a first end (64a) coupled to the second cover plate (16); a second end (64b) coupled to the motor drive (62); and one or more sidewalls (64c) extending between the first and second ends (64a, 64b) that defines an interior passage through which the longitudinal shaft (58) extends. The sidewalls (64c) include one or more inspection openings (64d) that are sized and arranged to permit visual access to the longitudinal shaft (58) and to facilitate inspection and servicing of shaft-retention features. The shaft-coupling structure (64) further includes an interior coupling interface proximate the first end (64a) for receiving the second end of the shaft (58) and an exterior coupling interface proximate the second end (64b) for receiving the output member of the motor drive (62). A locating shoulder or centering feature at the first end (64a) mates with the second cover plate (16) to maintain coaxial alignment across the mechanical seal.

In assembly, rotational power from the motor drive (62) is transmitted through the shaft coupling structure (64) to the longitudinal shaft (58). Torque passes across the mechanical seal at the drive penetration, then through the submersible joint assembly (74) situated immediately inside the second cover plate (16), and into the internal mixing or flow conditioning element located within the reactor chamber (10f). Concurrently, the longitudinal shaft (58) couples through the first cover plate (14) (via opening 14a) to drive the rotor (58c) positioned within the stator (56) of the stator assembly (51), integrating dosing and internal conditioning functions while maintaining pressure integrity.

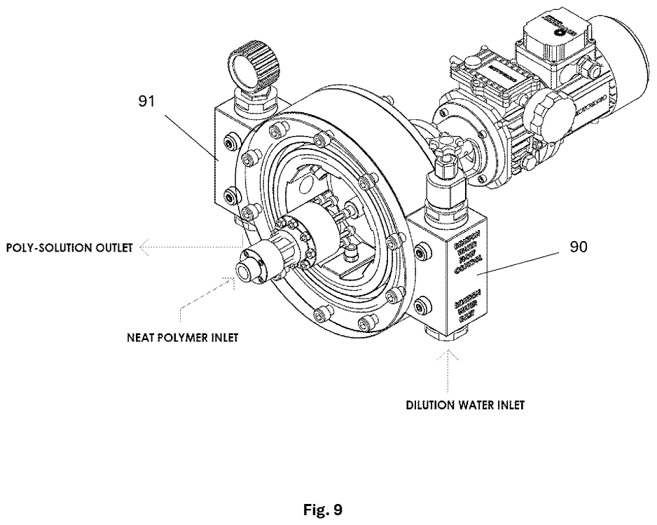

During operation, dilution water enters the annular reactor (10) through the inlet (90d) at the first process port (90) and is conveyed through the internal channel (90f) of the first process port (90) into the inlet channel (10g) of the reactor body (10c), as shown in FIGS. 9 and 11. The inlet channel (10g) delivers the water into the internal channel (10e) of the annular reactor (10), from which the water is released into the reactor chamber (10f) through the one or more spray nozzles (24). The water discharged through the spray nozzles (24) mixes with neat polymer introduced through the polymer-inlet opening (52a) of the exterior stator coupling (52) and conveyed through the rotor (58c) rotating within the stator (56) of the stator assembly (51). After mixing and conditioning within the reactor chamber (10f), the resulting polymer solution is guided through an outlet channel (10h) in the reactor body (10c) toward the second process port (91) and exits the system through the outlet (91d) at the first end (91a) of the second process port (91).

The annular reactor (10) is configured for horizontal or vertical mounting and includes mounting pads or brackets on the exterior surfaces of the reactor body (10c) or cover plates (14, 16). These mounting features allow the reactor (10) to be supported on a drum frame, tote frame, or inline piping structure. Each fastened interface on the annular reactor (10) includes accessible service fasteners engineered to permit disassembly without disturbing the reactor body (10c). The first cover plate (14) includes coupling-specific bolts that attach the interior stator coupling (54) and isolate internal bolts from the process fluid using gaskets or O-rings (42). The second cover plate (16) includes adjusting bolts used to set axial preload on the mechanical seal.

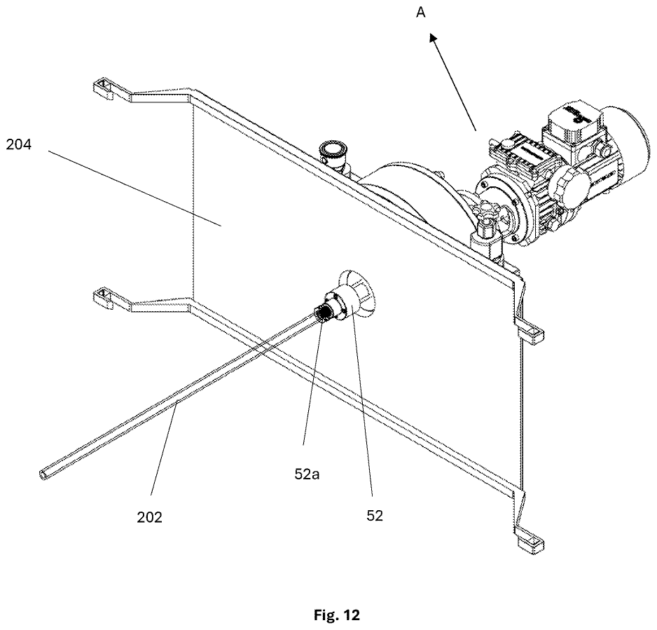

In one embodiment, shown in FIGS. 12-15, the modular annular dosing and mixing reactor system (A) is mounted directly onto the upper opening of a drum-type polymer container (200). In this configuration, the polymer inlet (52a) of the exterior stator coupling unit (52) is fluidly connected to a suction-tube assembly (202) that extends downward into the drum container (200) to extract neat polymer from the container interior. The suction-tube assembly (202) comprises a longitudinal pickup tube extending from the polymer inlet opening (52a) of the exterior stator coupling (52) into the interior of a polymer container (200), together with an upper connector and a container-mounting interface that support the tube in vertical alignment and establish a sealed fluid pathway for withdrawing neat polymer from the container (200) into the polymer dosing interface (50). The suction-tube assembly (202) is supported by a drum-adapter plate (204) that interfaces with the upper rim of the drum container (200) to maintain alignment of the suction tube relative to the polymer inlet (52a). The annular reactor (10), the motor drive (62), the dilution-water inlet associated with the first process port (90, 90d), the polymer-solution outlet associated with the second process port (91, 91d), and the associated valves are arranged above the drum opening so that the system forms an integrated drum-mounted activation and dosing unit. This embodiment enables direct withdrawal of neat polymer from a 55-gallon drum container (200) without intermediate transfer equipment and allows the dosing and mixing components to be supported entirely by the drum-mounting structure provided by the drum-adapter plate (204) and suction-tube assembly (202).

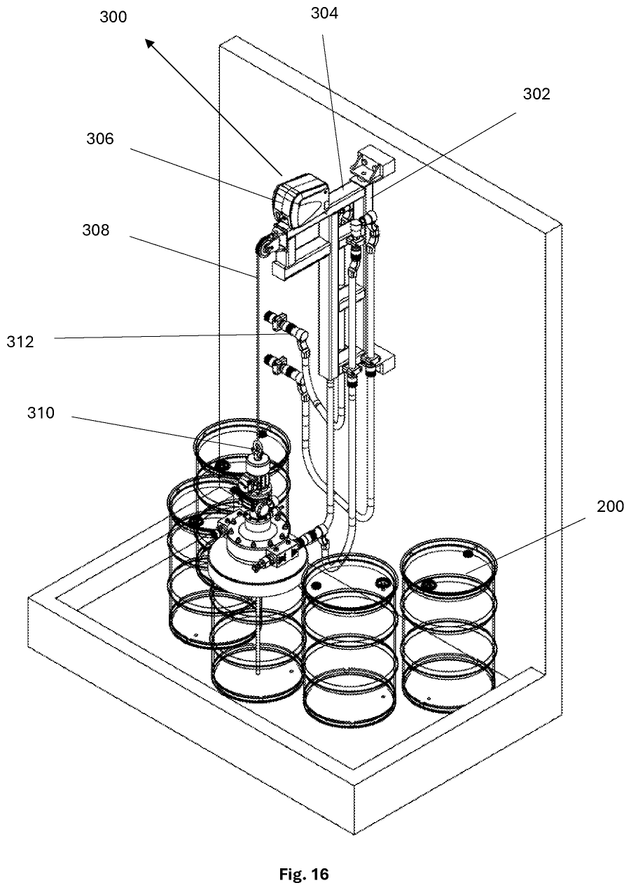

In another embodiment, shown in FIGS. 16-19, the modular annular dosing and mixing reactor system (A) is mounted to a rotating-crane installation (300) positioned adjacent to multiple neat-polymer containers. The rotating-crane installation (300) includes a wall-mounted crane column (302) secured to a structural wall, and a horizontal boom (304) rotatably mounted to the crane column (302) so that the boom (304) can pivot about the column along a horizontal arc. This rotational interface at the column-to-boom joint provides the slewing motion needed to swing and laterally reposition the reactor system (A) across several adjacent polymer containers within the crane's operating envelope. An electrical winch assembly (306) is mounted to the crane boom (304) and includes a load line (308) terminating in a hook-latch connector (310) adapted to attach to the motor drive (62) or to a dedicated lifting bracket on the reactor system (A). Flexible quick-connect and swivel hose assemblies (312) are connected to the dilution-water inlet—via the first process port (90) and its inlet (90d)—and to the polymer-solution outlet—via the second process port (91) and its outlet (91d). The rotational capability of the wall-mounted boom (304), together with the vertical travel provided by the electrical winch (306) and load line (308), allows the reactor system (A) to be slewed and raised or lowered to align the polymer-inlet opening (52a) with a suction-tube assembly extending into a selected drum or tank. This embodiment preserves the same annular-reactor flow geometry and dosing pathway described elsewhere—dilution water admitted through the first process port (90) is discharged through spray nozzles (24) into the reactor chamber (10f) to mix with neat polymer delivered through the stator assembly (51)—while enabling rapid changeover between multiple containers without disconnecting hard piping.

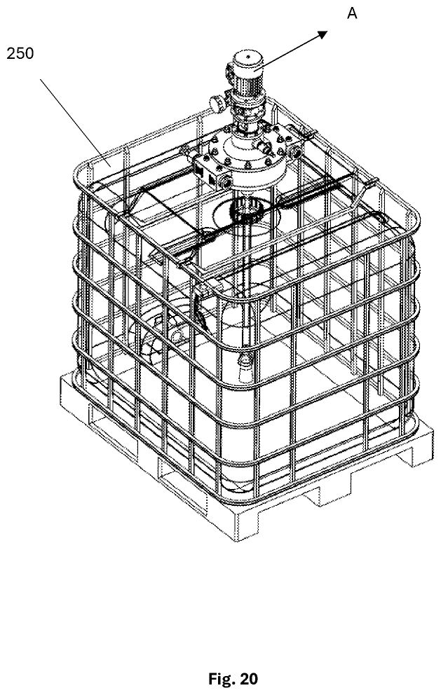

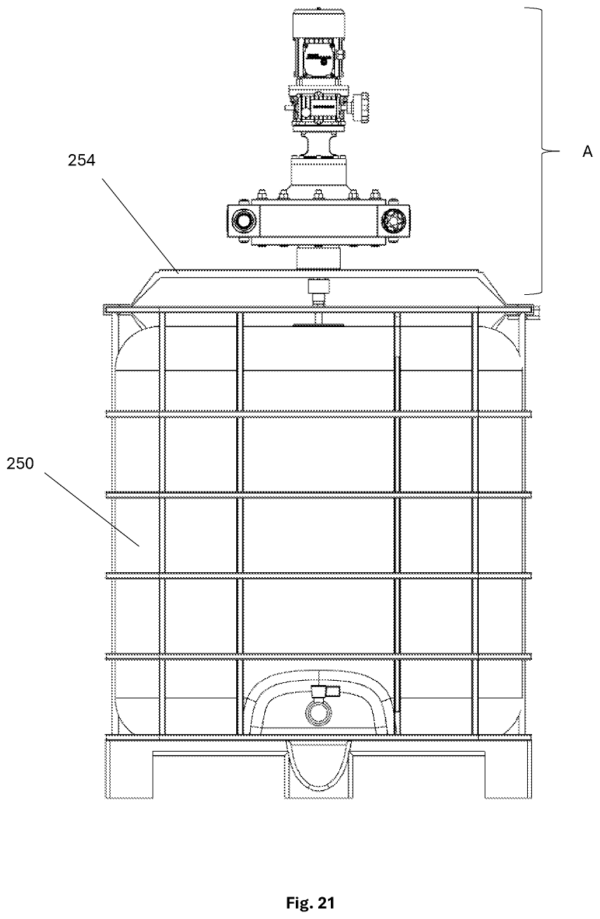

In yet another embodiment, shown in FIGS. 20 and 21, the modular annular dosing and mixing reactor system (A) is mounted onto a tote-bin container, such as a 250-gallon intermediate bulk container (250). A tote-mounting adapter structure (254) supports the annular reactor (10), the polymer dosing interface (50) including the stator assembly (51), and the motor drive (62) on an upper frame region of the tote (250), thereby forming a fully integrated tote-mounted liquid-polymer dosing and activation unit. The exterior stator coupling unit (52) includes a polymer-inlet connection (52a) that is fluidly connected to a suction-tube assembly (202) extending downward into the tote container (250) to withdraw neat polymer directly from the container interior. The tote-mounted configuration further includes a dilution-water control valve (22), a polymer-solution outlet associated with the second process port (91) and its outlet (91d), a pressure gauge, and a pressure relief valve positioned on the frame-mounted assembly above the tote. The mounting arrangement secures the dosing and mixing components in stable alignment over the tote opening so the system utilizes the tote (250) as the polymer supply while preserving the annular-reactor flow geometry and the dosing-interface structure described herein.

During use, dilution water is admitted through the first process port (90) at its inlet (90d) and conveyed into the inlet channel (10g) and the internal channel (10e) of the annular reactor (10), from which it is discharged via the one or more spray nozzles (24) into the reactor chamber (10f). In parallel, neat polymer is drawn from the tote container (250) through the suction-tube assembly (202) to the polymer-inlet opening (52a) of the exterior stator coupling (52) and then through the stator assembly (51), entering the annular reactor (10) for mixing with the dilution water. The resulting polymer solution exits the reactor via the outlet channel (10h) and is withdrawn through the second process port (91) at the outlet (91d) for delivery downstream. The pressure gauge provides real-time pressure indication during operation, while the pressure relief valve mounted on the assembly protects the system against over-pressure events.

While illustrative embodiments have been shown and described—including drum-mounted, tote-mounted, and wall-mounted rotating-crane configurations—the modular annular dosing and mixing reactor system (A) is not limited to the particular arrangements disclosed. Variations in the geometry of the annular reactor (10), numbers and placements of spray nozzles (24), selection and arrangement of process ports (90, 91), materials and sealing elements (42), and the construction of the polymer dosing interface (50)—including the stator assembly (51), exterior stator coupling (52) with polymer inlet opening (52a), interior stator coupling (54), stator (56), rotor (58c), longitudinal shaft (58), mechanical seal (72), and shaft-coupling structure (64)—may be made without departing from the spirit and scope of the invention. Likewise, alternative container interfaces, suction-tube assemblies (202), adapter structures (e.g., drum adapter (204) or tote adapter (254)), instrumentation such as pressure gauges and pressure relief valves, and mounting hardware (18) may be substituted or rearranged to suit specific site constraints, capacities, or service requirements, provided that the system maintains the annular flow path with controlled introduction of dilution water and neat polymer for mixing within the reactor chamber (10f) and discharge through the outlet channel (10h). Accordingly, the invention is defined by the claims and all equivalents thereof, and no single feature or element described herein should be construed as essential unless expressly recited in the claims

What is claimed is:

1. A modular annular dosing and mixing reactor system, comprising:
an annular reactor including a reactor body having an external wall and an internal wall that together define a continuous circumferential internal channel surrounding a reactor chamber, the annular reactor further including an inlet channel and an outlet channel, and one or more spray nozzles mounted on or through the internal wall and oriented to discharge fluid from the internal channel into the reactor chamber;
a first cover plate secured to a first end of the reactor body and a second cover plate secured to a second end of the reactor body, each of the first cover plate and the second cover plate having a central opening, the central openings being coaxially aligned;
a first process port having a port body with an inlet and an internal port channel in fluid communication with the inlet channel so that fluid admitted at the inlet is conveyed to the internal channel for discharge via the spray nozzles into the reactor chamber;
a second process port having a port body with an outlet and an internal port channel in fluid communication with the outlet channel to withdraw mixed contents from the reactor chamber; and
a polymer dosing interface comprising:
(i) a stator assembly including an exterior stator coupling defining a polymer inlet opening, an interior stator coupling, and a stator captured between the exterior and interior stator couplings, and a rotor positioned within the stator;
(ii) a longitudinal shaft extending through the central opening of the first cover plate and through the central opening of the second cover plate, the longitudinal shaft being coupled at a first end to the rotor and at a second end to a shaft-coupling structure mounted to the second cover plate and for connection to a motor drive; and
(iii) a mechanical seal arranged at a drive penetration of the second cover plate and surrounding the longitudinal shaft to maintain pressure integrity;
wherein the polymer inlet opening communicates through the stator assembly into the internal channel of the reactor body.

2. The system of claim 1, wherein at least one of the first process port and the second process port includes a replaceable wear-interface component received in a through-bore of the reactor body or a cover plate and a sealing element positioned between the replaceable wear-interface component and the reactor body or cover plate to isolate thread loads from the reactor body.

3. The system of claim 1, wherein the annular reactor further comprises a plurality of spray nozzles arranged circumferentially around the internal wall of the annular reactor to provide distributed discharge of the first substance into the reactor chamber.

4. The system of claim 1, wherein each spray nozzle includes a nozzle-to-wall seal positioned between the nozzle body and the wall of a corresponding nozzle bore to maintain a fluid-tight interface.

5. The system of claim 1, wherein the first process port further comprises a flow-control valve mounted at a second end of the port body for regulating pressure or volumetric inflow of the first substance.

6. The system of claim 1, wherein the replaceable wear-interface component comprises a threaded insert, a reducer, a bushing, a union, or a wear sleeve.

7. The system of claim 1, wherein the exterior stator coupling of the stator assembly defines a polymer-inlet passage extending axially toward the stator.

8. The system of claim 1, wherein the interior stator coupling of the stator assembly comprises a longitudinal housing coupled to the first cover plate and aligned with the central opening of the first cover plate to provide access for coupling between the longitudinal shaft and the rotor positioned within the stator.

9. The system of claim 1, wherein the first cover plate comprises a transparent or translucent material configured to permit visual inspection of flow, mixing, or reaction conditions within the reactor chamber.

10. The system of claim 1, wherein the annular reactor further comprises a pressure gauge mounted to the second process port or to the second cover plate.

11. The system of claim 1, wherein the system is mounted on a drum-type polymer container and further comprises a suction-tube assembly fluidly connected to the polymer-inlet opening of the exterior stator coupling to withdraw neat polymer from an interior of the drum, and a drum-adapter plate positioned at an upper opening of the drum to support and align the suction-tube assembly relative to the polymer-inlet opening.

12. The system of claim 1, wherein the system is mounted on a tote-bin container and further comprises a tote-mounting adapter structure supporting the annular reactor, the polymer dosing interface, and a motor drive on an upper frame region of the tote, and a suction-tube assembly fluidly connected to the polymer-inlet opening of the exterior stator coupling to withdraw neat polymer from an interior of the tote.

13. The system of claim 1, further comprising a wall-mounted rotating-crane installation including a crane column and a pivotable boom, an electrical winch mounted to the boom and having a load line terminating in a hook-latch attachable to the system, and flexible quick-connect swivel hose assemblies connected respectively to the first process port and the second process port, wherein rotation of the boom about the crane column slews the system laterally to position the polymer-inlet opening over a selected container and the winch raises or lowers the system to align with a suction-tube assembly extending into the container.

14. A method of using the modular annular dosing and mixing reactor system of claim 1, comprising:
introducing a first substance into the first process port at its inlet so that the first substance flows through the internal port channel of the first process port and into the inlet channel of the annular reactor;
directing the first substance from the inlet channel into the continuous circumferential internal channel of the annular reactor and discharging the first substance from the internal channel into the reactor chamber through the one or more spray nozzles mounted on or through the internal wall;
withdrawing a second substance from an external supply and delivering the second substance into the polymer-inlet opening of the exterior stator coupling of the stator assembly;
advancing the second substance through the stator assembly and into the internal channel of the reactor body for mixing with the first substance within the reactor chamber;
rotating the longitudinal shaft by driving the shaft-coupling structure with a motor drive so that the longitudinal shaft transmits rotational motion to the rotor positioned within the stator;
forming a mixed or conditioned liquid within the reactor chamber by contact between the discharged first substance and the second substance delivered through the stator assembly; and
withdrawing the mixed or conditioned liquid from the reactor chamber through the outlet channel and the internal port channel of the second process port for discharge at the outlet of the second process port.

15. The method of claim 14, further comprising positioning the system on a drum-type polymer container, coupling a suction-tube assembly to the polymer-inlet opening of the exterior stator coupling, and drawing neat polymer from an interior of the drum into the polymer-inlet opening.

16. The method of claim 14, further comprising supporting the system on an upper frame region of a tote-bin container using a tote-mounting adapter, inserting a suction-tube assembly into the tote-bin container, and regulating inflow of the first substance by operating a dilution-water control valve in fluid communication with the first process port.

17. The method of claim 14, wherein the system is supported by a wall-mounted rotating-crane installation, and further comprising slewing a pivotable crane boom to position the polymer-inlet opening over a selected container and operating an electrical winch to raise or lower the system to align the polymer-inlet opening with a suction-tube assembly extending into the container.

18. The method of claim 14, further comprising monitoring reactor pressure with a pressure gauge during introduction of the first substance and actuating a pressure-relief valve to vent fluid to a safe location when a predetermined set pressure is reached.

19. The method of claim 14, wherein the system includes an internal mixing or flow-conditioning element coupled to the longitudinal shaft on a chamber side of the drive penetration, and further comprising transmitting torque through a submersible joint assembly to rotate the internal mixing or flow-conditioning element while the first and second substances are introduced.
